(19) United States
(12) Patent Application Publication
(10) Pub. No.: US 2020/0106933 A1
(43) Pub. Date: Apr. 2, 2020

(54) REMOTE READING OF A METER DIAL

(71) Applicant: DOMINION ENERGY, INC., Richmond, VA (US)

(72) Inventors: KUMUD J. LATA, GLEN ALLEN, VA (US); ANGELYN LEGASPI, RICHMOND, VA (US); JODY R. TIDD, JANELEW, WV (US); STEVE WOOTEN, POWHATAN, VA (US); BERNIE W. YEAGER, BRIDGEPORT, WV (US)

(21) Appl. No.: 16/590,602

(22) Filed: Oct. 2, 2019

Related U.S. Application Data
(60) Provisional application No. 62/740,377, filed on Oct. 2, 2018.

(51) Int. Cl. H04N 5/225; G06K 9/62; H04Q 9/02; H04N 5/232; H04Q 9/04

(52) U.S. Cl. CPC H04N 5/2252; G06K 9/6257; H04Q 9/02; H04N 5/232411; H04Q 2209/40; H04Q 9/04; G06K 2209/03; G06K 2209/01; H04N 5/23203

(57) ABSTRACT

A system for remote reading of a utility meter dial comprises a digital camera, a controller in communication with the digital camera, and a computing device. The digital camera is positioned and adapted to photograph a utility meter. The controller is configured to send an instruction to the camera to take a photograph of the meter according to a predefined schedule. The controller is configured to receive the photograph from the camera and to transmit the photograph. The computing device is configured to receive the photograph from the controller and to perform image analysis on the photograph to extract one or more numbers corresponding to one or more numbers displayed on a dial of the meter.

### CROSS-REFERENCE TO RELATED APPLICATIONS

This application claims priority to pending U.S. Provisional Application Ser. No. 62/740,377, filed Oct. 2, 2018, the contents of which are incorporated herein by reference in their entirety.

### FIELD OF THE INVENTION

The present invention relates generally to remote reading of utility meters.

### BACKGROUND OF THE DISCLOSURE

Compressor stations are an integral part of the natural gas pipeline network that moves natural gas from individual producing well sites to end users. As natural gas moves through a pipeline, distance, friction, and elevation differences slow the movement of the gas, and reduce pressure. Compressor stations are placed strategically along the pipeline network to help maintain the pressure and flow of gas.

At these compressor stations there are gas meters to measure the flow of gas, typically in cubic feet. Such a meter displays the amount of gas that has flowed through it (in cubic feet) using one of several different styles of display. One large company that operates gas pipelines in the United States maintains about 250 of these meters at various compressor stations. Currently, these meters must be manually read in order to keep track of the gas flow. Monthly, a field worker travels to each compressor station to look at the meter and take the reading, write down the number on the display, and later provide this information to a clerk to be entered in a tracking system.

It is labor-intensive to have to regularly send a worker to each compressor station. Some of the compressor stations are located in remote areas, and travel to these stations can be a safety concern during bad weather. Also, this manual process of reading a meter and manually entering the data is subject to human error.

In addition to compressor stations, the placement and location of manual meters may be found in isolated metering and regulation stations, isolated metering points, and various other facilities within the gas industry

### BRIEF SUMMARY OF THE DISCLOSURE

A system for remote reading of a utility meter dial comprises a digital camera, a controller in communication with the digital camera, and a computing device. The digital camera is positioned and adapted to photograph a utility meter. The controller is configured to send an instruction to the camera to take a photograph of the meter according to a predefined schedule. The controller is configured to receive the photograph from the camera and to transmit the photograph. The computing device is configured to receive the photograph from the controller and to perform image analysis on the photograph to extract one or more numbers corresponding to one or more numbers displayed on a dial of the meter.

The controller may be further configured to, prior to sending the instruction to take the photograph of the meter, send an instruction to the camera to wake from an inactive state.

The computing device may be further configured to store and/or transmit the extracted numbers.

The computing device may be remotely located from the controller, and the controller may transmit the photograph to the computing device via a wireless communication method.

The utility meter may comprise an analog utility meter displaying a plurality of number rings and corresponding needles. The computing device may be configured to perform an image analysis on the photograph of the analog utility meter by (1) applying a deep learning model to the photograph to extract each of the corresponding number rings and needles from the photograph, the deep learning model created using a plurality of sample images of utility meters, (2) finding an angle of each of the plurality of needles, (3) based on the angle of each of the plurality of needles, determining a number at which each needle is pointing, and (4) concatenating the number at which each needle is pointing into a single multi-digit number.

The utility meter may comprise a digital utility meter displaying a plurality of numeric digits. The computing device may be configured to perform an image analysis on the photograph of the digital utility meter by (1) blurring the photograph, (2) applying erosion on the photograph to remove unwanted information, (3) performing contour detection to remove noise and extract an image of the numeric digits, and (4) performing optical character recognition mapping on the image of the numeric digits to extract a multi-digit number value from the image of the numeric digits.

The system may further comprise an explosion-proof enclosure housing the camera and the controller. The system may further comprise an articulating arm having a proximal end and a distal end, such that the enclosure is affixed to the distal end of the articulating arm and the proximal end of the articulating arm is adapted to be affixed to a pipe connected to the utility meter. The articulating arm may comprise at least two length-adjustable elongated members that are perpendicular to each other. The articulating arm may further comprise a rotational adjustment mechanism connected to at least one of the adjustable elongated members.

The system may further comprise a Wi-Fi or cellular antenna electrically connected to the controller, such that the controller transmits the photograph to the computing device via the antenna.

Alternative embodiments of the invention comprise a computer-implemented method for remote reading of a utility meter dial. The method comprises receiving, by a computer, a digital photograph of a utility meter; and performing, by the computer, image analysis on the photograph to extract one or more numbers corresponding to one or more numbers displayed on a dial of the meter.

The method may further comprise sending, by a processing device, an instruction to a digital camera to take the photograph of the meter according to a predefined schedule. The method may further comprise, prior to sending the instruction to take the photograph of the meter, sending, by the processing device, an instruction to the camera to wake from an inactive state.

The computing device may be remotely located from the utility meter, and the computer may receive the photograph via a wireless communication method.

The utility meter may comprise an analog utility meter displaying a plurality of number rings and corresponding needles. Performing image analysis on the photograph may comprise (1) applying a deep learning model to the photograph to extract each of the corresponding number rings and needles from the photograph, the deep learning model created using a plurality of sample images of utility meters; (2) finding an angle of each of the plurality of needles; (3) based on the angle of each of the plurality of needles, determining a number at which each needle is pointing; and (4) concatenating the number at which each needle is pointing into a single multi-digit number.

The utility meter may comprise a digital utility meter displaying a plurality of numeric digits. Performing image analysis on the photograph may comprise (1) blurring the photograph; (2) applying erosion on the photograph to remove unwanted information; (3) performing contour detection to remove noise and extract an image of the numeric digits, and (4) performing optical character recognition mapping on the image of the numeric digits to extract a multi-digit number from the image of the numeric digits.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a schematic block diagram of a system for remote reading of a utility meter dial, in accordance with embodiments of the invention.

FIG. 2 is a perspective view of an enclosure housing components of the system of FIG. 1.

FIG. 3 is a perspective view of an installation of a portion of FIG. 1.

FIG. 4 is an image of a utility meter dial as captured by a camera of the system of FIG. 1.

FIGS. 5-7 illustrate steps of an image analysis performed by the system of FIG. 1.

FIG. 8 is a front view of an alternative type of dial of a gas meter that may be read using the system of FIG. 1.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

Embodiments of the invention comprise a system, method, computer-implemented method, and computer program product for remotely reading a utility meter, such as a gas meter. Embodiments of the invention provide a low-cost, intrinsically safe, and easy-to deploy solution using (for example) IoT (Internet of Things) camera technology to automate the meter reading. The camera is installed facing the meter so that the camera can periodically (e.g., on a predefined schedule) take a photograph of the meter and send the image to the cloud, where image analytics are used to convert the image to a digital meter reading, thereby providing a numeric value corresponding to the amount of gas that has flowed that can be electronically stored and used (such as for billing purposes).

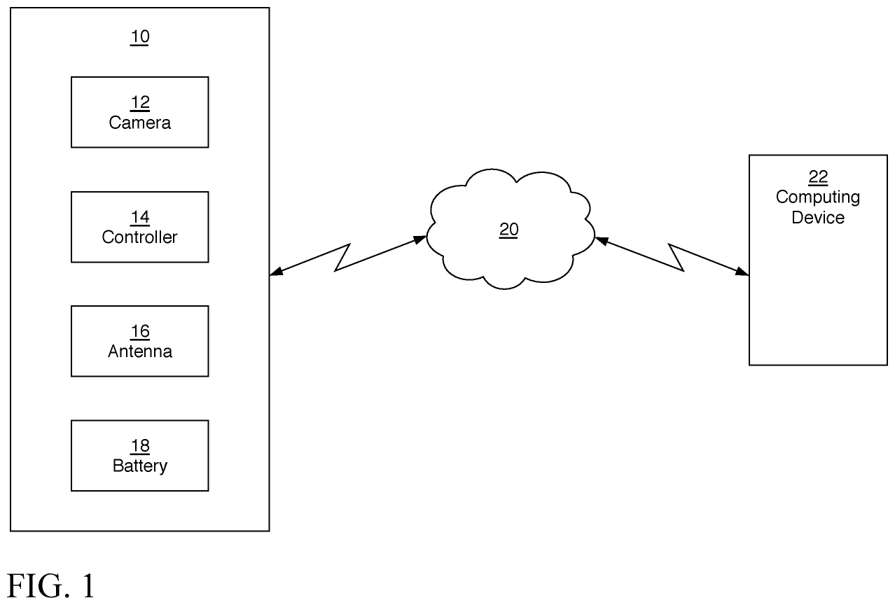

Referring now to FIG. 1, a system for remotely reading a utility meter comprises a device 10 that is located at the location of the meter to be remotely read. The remote device 10 comprises a camera 12, a controller 14, an antenna 16, and one or more batteries 18. Any suitable digital camera may be used. In one exemplary embodiment of the invention, an Arducam 2 megapixel camera is used. The controller 14 may comprise a microprocessor, dedicated or general purpose circuitry (such as an application-specific integrated circuit or a field-programmable gate array), a suitably programmed computing device, or any other suitable means for controlling the operation of the device. The controller 14 is electrically connected to the camera 12 and, in one exemplary embodiment of the invention, communicates with the camera using the serial peripheral interface (SPI) protocol. The antenna 16 may comprise any suitable antenna for the specific type of wireless communication to be used by the device. In one exemplary embodiment, the device 10 will communicate via cellular LTE technology (specifically serial multi-segment compression over https via Narrowband Internet of Things (NB-IoT)), so the antenna 16 will comprise a cellular antenna. In alternative embodiments, the device 10 may communicate via Wi-Fi, so the antenna 16 would comprise a Wi-Fi antenna. One or more batteries 18 of any suitable type will provide power to the camera 12 and the controller 14. In one exemplary embodiment, the batteries 18 comprise lithium polymer (LiPo) batteries.

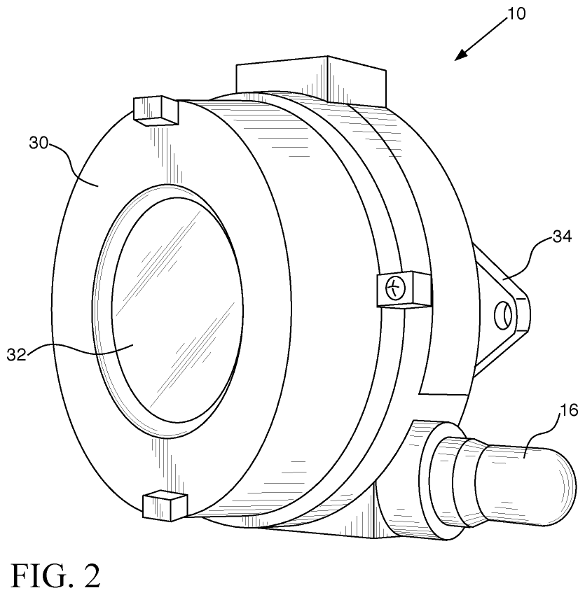

The camera 12, the controller 14, and the one or more batteries 18 are preferably housed in a certified explosion-proof (e.g., Class 1, Division 2) enclosure 30 as seen in FIG. 2. The enclosure 30 has one or more mounting tabs 34 to enable mounting of the device as described below. The enclosure 30 has a clear window 32 (constructed of glass or plastic) to enable the camera 12 to photograph the meter from inside the enclosure 30. Thus, the camera 12 is mounted within the enclosure such that the camera lens is aligned with the window 32. The antenna 16 protrudes from the enclosure 30 to enable its signal to be broadcast.

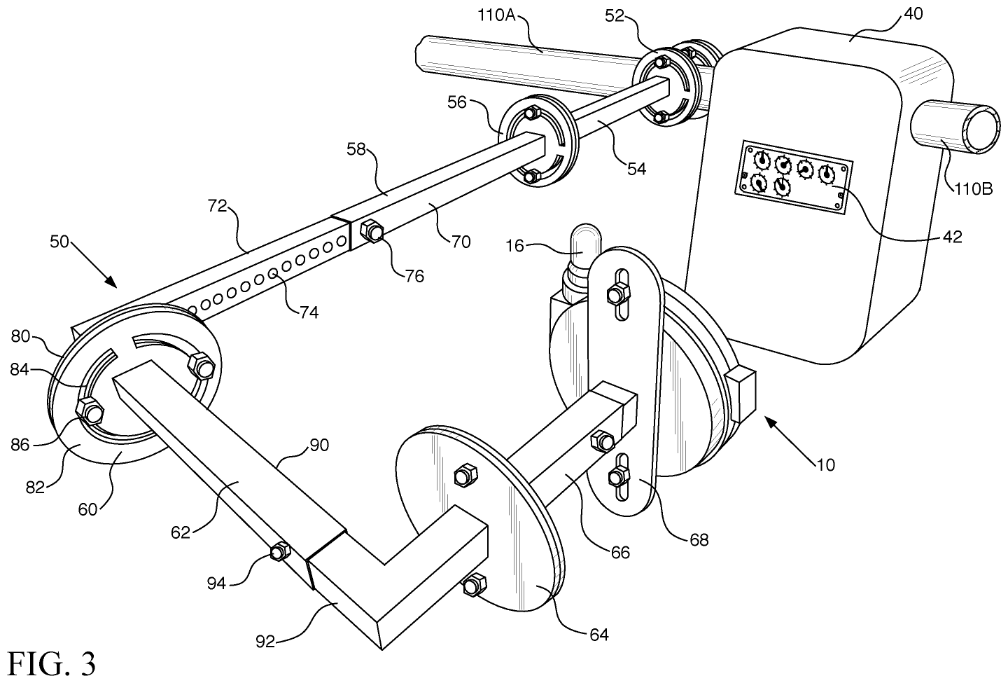

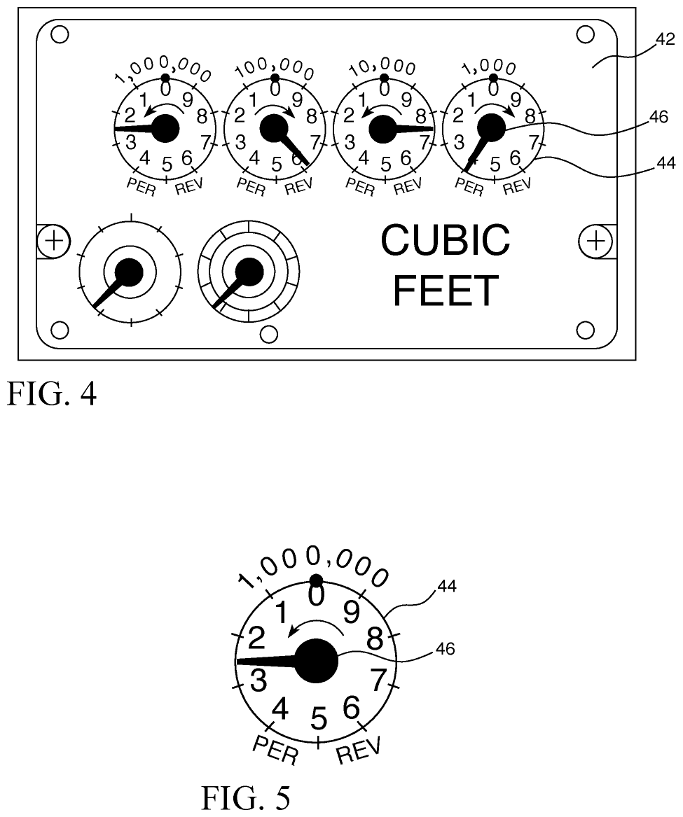

Referring now to FIG. 3, a utility (gas) meter 40 is shown with a dial 42 that tracks the amount of gas that has flowed through the meter 40. Gas flows into the meter through an input pipe 110A and out of the meter through an output pipe 110B. It is the dial 42 that is photographed such that the numbers indicating the gas flow can be extracted and recorded. The device 10 is mounted near the utility meter to be read and positioned such that the camera 12 is aimed at the dial 42 of the meter 40. Any suitable mounting bracket or other hardware may be used to hold the device 10 in the proper position to photograph the meter dial. There are different styles of meters that use different display mechanism of displaying the gas flow (these display mechanisms will be generically referred to herein as “dials,” although some versions will not have actual dials). FIG. 4 shows one common style of meter dial 42 in which there are four rotating needles 46 and corresponding number rings 44, each representing one digit in a multi-digit number that indicates the total gas flow (2,674,000 cubic feet in FIG. 4). The meter dial of FIG. 4 is typically termed an analog dial and a meter that had such an analog meter dial is typically termed an analog meter. FIG. 8 shows another common style of meter dial 100 in which there is a four digit digital display. The meter dial of FIG. 8 is typically termed a digital dial and a meter that had such a digital meter dial is typically termed a digital meter.

In the illustrated embodiment, an articulating arm 50 holds the device 10 in position. The articulating arm 50 has multiple position adjustment mechanisms to readily enable the proper positioning of the device 10 relative to the meter 40. The articulating arm 50 has a proximal end and a distal end and may be mounted or secured to any suitable surface or structure. In the illustrated embodiment, the proximal end of articulating arm 50 is secured to the input pipe 110A via mounting bracket 52 and the device 10 is affixed to the distal end of the articulating arm 50 via mounting plate 68. The articulating arm 50 comprises two length-adjustable elongated members 58, 62 (more or fewer could be used) that are affixed to the mounting bracket 52 via a short intermediary member 54 and that are generally perpendicular to each other.

The first length-adjustable elongated member 58 is affixed to a rotational adjustment mechanism 56, which is affixed to the intermediary member 54. The rotational adjustment mechanism 56 enables the first length-adjustable elongated member 58 to be rotated about its longitudinal axis. Such a rotation would move the device 10 up or down relative to the meter 40 along an arc whose center is on the longitudinal axis of the first length-adjustable elongated member 58. The first length-adjustable elongated member 58 comprises a sleeve portion 70 and an inner telescoping portion 72 that slides in and out of the sleeve portion 70 to adjust the length of the first length-adjustable elongated member 58 to move the device 10 toward or away from the meter 40. A fastener 76 (e.g., bolt and nut) is secured to one of the holes 74 in the inner telescoping portion 72 to set the length of the first length-adjustable elongated member 58.

The second length-adjustable elongated member 62 is affixed to a rotational adjustment mechanism 60, which is affixed to the first length-adjustable elongated member 58. The rotational adjustment mechanism 60 enables the second length-adjustable elongated member 62 to be rotated about its longitudinal axis. Such a rotation would move the device 10 up or down relative to the meter 40 along an arc whose center is on the longitudinal axis of the second length-adjustable elongated member 62. The second length-adjustable elongated member 62 comprises a sleeve portion 90 and an inner telescoping portion 92 that slides in and out of the sleeve portion 90 to adjust the length of the second length-adjustable elongated member 62 to move the device 10 left or right relative to the meter 40. A fastener 94 (e.g., bolt and nut) is secured to one of the holes (not visible) in the inner telescoping portion 92 to set the length of the second length-adjustable elongated member 62.

A rotational adjustment mechanism 64 is affixed to the distal end of the inner telescoping portion 92 of the second length-adjustable elongated member 62. A short intermediary member 66 is affixed to the rotational adjustment mechanism 64. The mounting plate 68 is affixed to the distal end of the intermediary member 66. The device 10 is affixed to the mounting plate 68. The rotational adjustment mechanism 64 enables the intermediary member 66 to be rotated about its longitudinal axis. Such a rotation would spin the device 10 to set its desired orientation relative to the meter 40. The short intermediary member 66 may also be length-adjustable similar to the first length-adjustable elongated member 58 and the second length-adjustable elongated member 62.

The rotational adjustment mechanisms 56, 60, 64 all have a similar structure, so only the rotational adjustment mechanism 60 will be described in detail herein. The rotational adjustment mechanism 60 comprises two planar discs 80, 82. The first planar disc 80 is affixed to the inner telescoping portion 72 of the first length-adjustable elongated member 58. The first planar disc 80 does not rotate. The first planar disc 80 has two threaded posts (not visible) protruding therefrom. The second planar disc 82 has two semi-circular slots 84 defined therein, each receiving one of the threaded posts. A nut 86 is threaded onto each threaded post to secure the second planar disc 82 to the first planar disc 80. When the nuts 86 are loosened, the second planar disc 82 may be rotated relative to the first planar disc 80. When the desired rotational position of the second planar disc 82 is achieved, the nuts 86 are tightened which secures the second planar disc 82 in that rotational position. The sleeve portion 90 of the second length-adjustable elongated member 62 is affixed to the rotational adjustment mechanism 60.

The system is typically configured to photograph the meter dial on a predefined schedule, for example, one a week or once a month. The camera 12 is typically in an inactive or “sleep” state until it is time to photograph the meter dial. The controller 14 determines when it is time to photograph the meter dial, and sends a signal to the camera 12 to “wake” the camera and then sends a signal to the camera 12 to cause the camera 12 to take a photograph. The controller 14 receives the photograph from the camera 12. The controller 14 then sends a signal to the camera to place the camera back into an inactive or “sleep” state. The controller 14 transmits the photograph via the internet 20 (or the “cloud”) to a computing device 22, typically via a wireless communication technology such as cellular or Wi-Fi. (The controller 14 may not transmit the photograph directly to the computing device 22. The controller 14 may transmit the photograph to a storage location, from which the computing device 22 may retrieve the photo.) The computing device 22 may be, for example, a server or computer, and is typically at a central location that is different from the remote location of the device 10. The computing device 22 typically receives similar photographs from many different meter reading devices at many different meter locations.

The computing device 22 performs image analysis on the photograph to extract one or more numbers corresponding to one or more numbers displayed on a dial of the meter. The computing device can then perform a variety of different actions with the extracted numbers, such as storing the extracted numbers or transmitting the extracted numbers.

The computing device 22 may use image processing software that is trained on different types of meters (e.g., different shape, dials, needles, etc.). The computing device 22 may use deep learning and shape geometric analytics for analog meters, and optical character recognition (OCR) for digital meters. The image in each photograph is processed against deep learning trained models to identify the type of meter, and geometrical analytics is run to convert analog reading to digital. OCR is used to extract digital numerals from digital meters.

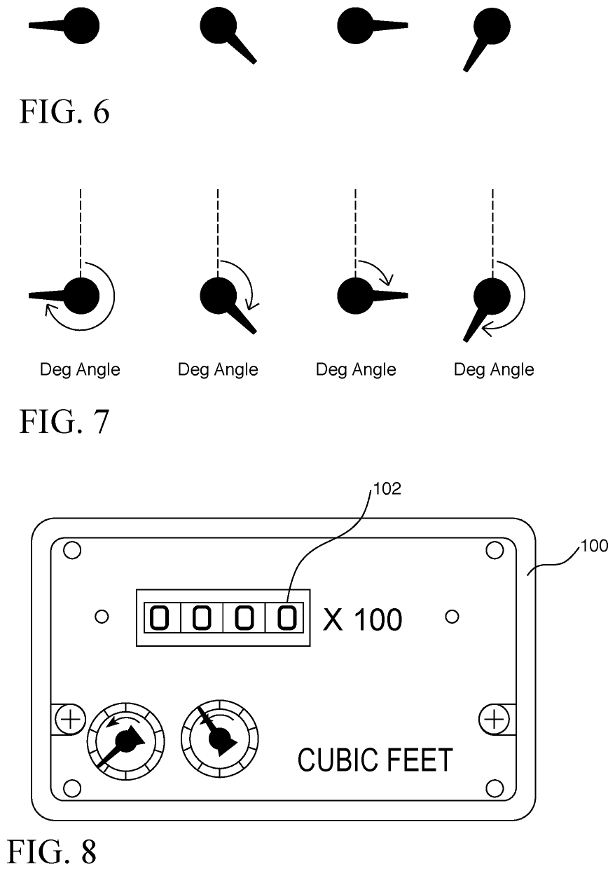

FIG. 4 is an example of a photographic image of an analog utility meter from which the numbers can be extracted by performing the following steps: (1) applying a deep learning model to the photograph to extract each of the corresponding number rings and needles from the photograph (FIG. 5 illustrates one such extracted number ring and needle), the deep learning model created using a plurality of sample images of utility meters, (2) finding an angle of each of the plurality of needles (FIG. 6 illustrates all of the extracted needles, while FIG. 7 illustrates the angle of each needle), (3) based on the angle of each of the plurality of needles, determining a number at which each needle is pointing (the number at which each needle is pointing is found by matching the angle to its corresponding number based on the deep learning model), and (4) concatenating the number at which each needle is pointing into a single multi-digit number.

FIG. 8 is an example of a photographic image of a digital meter dial from which the numbers can be extracted by performing the following steps: (1) blurring the photograph, (2) applying erosion on the photograph to remove unwanted information, (3) performing contour detection to remove noise and extract an image of the numeric digits, and (4) performing optical character recognition mapping on the image of the numeric digits to extract a multi-digit number from the image of the numeric digits.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A system for remote reading of a utility meter dial, the system comprising:
a digital camera, positioned and adapted to photograph a utility meter;
a controller in communication with the digital camera, the controller configured to send an instruction to the camera to take a photograph of the meter according to a predefined schedule, the controller configured to receive the photograph from the camera and to transmit the photograph; and
a computing device configured to receive the photograph from the controller and to perform image analysis on the photograph to extract one or more numbers corresponding to one or more numbers displayed on a dial of the meter.

2. The system of claim 1, wherein the controller is further configured to, prior to sending the instruction to take the photograph of the meter, send an instruction to the camera to wake from an inactive state.

3. The system of claim 1, wherein the computing device is further configured to store and/or transmit the extracted numbers.

4. The system of claim 1, wherein the computing device is remotely located from the controller; and
wherein the controller transmits the photograph to the computing device via a wireless communication method.

5. The system of claim 1, wherein the utility meter comprises an analog utility meter displaying a plurality of number rings and corresponding needles; and
wherein the computing device is configured to perform an image analysis on the photograph of the analog utility meter by (1) applying a deep learning model to the photograph to extract each of the corresponding number rings and needles from the photograph, the deep learning model created using a plurality of sample images of utility meters, (2) finding an angle of each of the plurality of needles, (3) based on the angle of each of the plurality of needles, determining a number at which each needle is pointing, and (4) concatenating the number at which each needle is pointing into a single multi-digit number.

6. The system of claim 1, wherein the utility meter comprises a digital utility meter displaying a plurality of numeric digits; and
wherein the computing device is configured to perform an image analysis on the photograph of the digital utility meter by (1) blurring the photograph, (2) applying erosion on the photograph to remove unwanted information, (3) performing contour detection to remove noise and extract an image of the numeric digits, and (4) performing optical character recognition mapping on the image of the numeric digits to extract a multi-digit number from the image of the numeric digits.

7. The system of claim 1, further comprising an explosion-proof enclosure housing the camera and the controller.

8. The system of claim 7, further comprising an articulating arm having a proximal end and a distal end;
wherein the enclosure is affixed to the distal end of the articulating arm; and
wherein the proximal end of the articulating arm is adapted to be affixed to a pipe connected to the utility meter.

9. The system of claim 8, wherein the articulating arm comprises at least two length-adjustable elongated members that are perpendicular to each other.

10. The system of claim 9, wherein the articulating arm further comprises a rotational adjustment mechanism connected to at least one of the adjustable elongated members.

11. The system of claim 1, further comprising a Wi-Fi_33 or cellular antenna electrically connected to the controller, wherein the controller transmits the photograph to the computing device via the antenna.

12. A computer-implemented method for remote reading of a utility meter dial, the method comprising:
receiving, by a computer, a digital photograph of a utility meter; and
performing, by the computer, image analysis on the photograph to extract one or more numbers corresponding to one or more numbers displayed on a dial of the meter.

13. The method of claim 12, further comprising:
sending, by a processing device, an instruction to a digital camera to take the photograph of the meter according to a predefined schedule.

14. The method of claim 13, further comprising:
prior to sending the instruction to take the photograph of the meter, sending, by the processing device, an instruction to the camera to wake from an inactive state.

15. The method of claim 12, wherein the computing device is remotely located from the utility meter; and
wherein the computer receives the photograph via a wireless communication method.

16. The method of claim 12, wherein the utility meter comprises an analog utility meter displaying a plurality of number rings and corresponding needles; and
wherein performing image analysis on the photograph comprises:
(1) applying a deep learning model to the photograph to extract each of the corresponding number rings and needles from the photograph, the deep learning model created using a plurality of sample images of utility meters;
(2) finding an angle of each of the plurality of needles;
(3) based on the angle of each of the plurality of needles, determining a number at which each needle is pointing; and
(4) concatenating the number at which each needle is pointing into a single multi-digit number.

17. The method of claim 12, wherein the utility meter comprises a digital utility meter displaying a plurality of numeric digits; and
wherein performing image analysis on the photograph comprises:
(1) blurring the photograph;
(2) applying erosion on the photograph to remove unwanted information;
(3) performing contour detection to remove noise and extract an image of the numeric digits, and
(4) performing optical character recognition mapping on the image of the numeric digits to extract a multi-digit number from the image of the numeric digits.
